(19) United States
(12) Patent Application Publication
(10) Pub. No.: US 2012/0282161 A1
(43) Pub. Date: Nov. 8, 2012

(54) PROCESS FOR PREPARING BIOCIDES

(76) Inventors: Ara Arshavirovich Abramyan, Moscow (RU); Mikhail Mefodievich Afanasyev, Moscow (RU); Viacheslav Ivanovich Beklemyshev, Moscow (RU); Konstantin Vitalievich Filippov, Moscow (RU); Igor Ivanovich Makhonin, Mendeleevo (RU); Umberto Orazio Giuseppe Maugeri, Calvignano (IT); Vladimir Aleksandrovich Solodovnikov, Moscow (RU)

(21) Appl. No.: 13/261,316

(22) PCT Filed: Dec. 13, 2010
(86) PCT No.: PCT/EP2010/069498

§ 371 Date: Jun. 7, 2012

(30) Foreign Application Priority Data
Dec. 11, 2009 (RU) RU2009145819

(51) Int. Cl. B01J 19/10; C01B 33/26

(52) U.S. Cl. 423/327.1; 204/157.42

(57) ABSTRACT

A process for the production of biocides possessing fungicidal and bactericidal properties is described wherein bentonite is activated with ions of sodium and the obtained intermediate product is intercalated by ions of metals of bactericidal action such as Ag⁺, Cu²⁺, Zn²⁺ by reaction in water solutions of inorganic salts of these metals, under the action of ultrasounds having a frequency of 20-50 Khz and intensity of 10-100 WT/cm².

### FIELD OF THE INVENTION

This invention relates to the manufacture of biocides possessing fungicidal and bactericidal properties and intended for application in hygiene and medicine, in compounds for topical use in the treatment of skin diseases (trophic ulcers, burns, dermatitis and dermopathy) and for preparations useful in other fields of technique, in particular, for the processing of fabric, polymers, building products and products for medical purpose.

### STATE OF THE ART

The use of metals having bactericidal action—Ag, Au, Pt, Pd, Cu, and Zn is widely known in the field of manufacturing of fungicides and bactericides (see H. E. Morton, Pseudomonas in Disinfection, Sterilisation and Preservation, ed. S. S. Block, Lea and Febider 1977 and N. Grier, Silver and Its Compounds in Disinfection, Sterilisation and Preservation, ed. S. S. Block, Lea and Febiger, 1977).

It is also known that substances change their chemical, physical and biological properties when in the form of particles having dimensions not higher than 100 nanometers (nanometer range).

Ultradispersed biocides containing silver are known [see E. M. Blagitko, etc. <<Silver in medicine>>, Novosibirsk: Nauka-center, 2004, 256 p.].

In the specification of the Russian patent RU 2259871 a biocide in the form of a colloidal solution of a nanostructured biocide based on metals nanoparticles is described. Said nanostructured biocide is obtained by dissolution of a metal salt and a water-soluble polymer in water and/or in a non aqueous solvent. The obtained solution is blown through a gaseous flow of nitrogen or argon and irradiated. As the metal salt, a salt of at least one metal chosen from the group comprising silver, copper, nickel, palladium and platinum is used. It is preferable to use a salt of silver, for example nitrate, perchlorate, sulfate or acetate. Polyvinylpirrolidone, copolymers of 1-vinylpirrolidone with acrylic or vinylacetic acids, with styrene or with vinylic alcohol are used as the polymer. Methanol, ethanol, isopropyl alcohol or ethylene glycol are used as the solvent. Surface-active substances are also added in the reactor in order to obtain a stable emulsion. The obtained nanocomposite biocides are used as antibacterial means, sterilising or deodorizing means.

However the above described method for obtaining a biocide is complicated and expensive because the synthesis is carried out in an atmosphere of inert gas and with application of a source of ionizing. radiations.

In the patent RU 2088234 (1997) a water-soluble bactericidal composition containing nanoclusters of zero-valent metallic silver stabilized with poly-N-vynilchlorridone-2 is described. The preparation of this bactericidal composition is carried out in an atmosphere of inert gases by reaction of a silver nitrate solution with a water solution of ethanol containing poly-N-polyvynilchlorridone-2; the reaction is carried out in darkness under heating up to 65-75° C.

However the presence of the stabilizer in these products limits the technological opportunities of their application in the final preparations.

According to Russian Patent RU 2278669 (2006) water solutions of silver salts are added to a water solution of arabinogalactan.

Ammonium or sodium hydroxyde is added in the solution. Silver is in a zero-valent condition according to the data of the X-ray diffraction analysis. The obtained arabinogalactans containing silver can be used in medicine as antiseptic means for topical application, as a medical preparation alternative to antibiotics and also as a component for bactericidal coatings.

However the use of the stabilizer, i.e. natural polysaccharide of arabinogalactan, as a reducer of silver ions up to a zero-valent condition and also, simultaneously, as the reaction dispersion media, increases the preparation costs.

Thus, the above mentioned processes for obtaining bactericidal preparations present technical difficulties and rather low stability of their liquid dispersions.

Patent RU 2330673 (2008) is considered the closest prior art in respect of the present invention and refers to the preparation of biocides based on bentonite intercalated by ions of metals.

According to the above said patent the process for obtaining the desired biocide consists of the following steps: in a first stage bentonite in Na-form is activated with ions of sodium by reaction with a water solution of chloride sodium followed by the removal of chlorine anions by washing and filtering of the obtained intermediate product; at the second stage, the obtained intermediate is intercalated by ions of metals having bactericidal action by reaction of water solutions of inorganic salts of these metals followed by removal of sodium salts by washing the product with deionized water. Then the product is filtered, dried and ground up to particles dimensions of 20-150 nanometers.

Silver nitrate and copper sulfate are used as inorganic salts of bactericidal metals for the intercalation.

Reaction of the bentonite with the named water solutions is carried out at each stage at a ratio: bentonite:solution as 1:(10-40) parts by weight. In the intercalation process a semi-finished product of bentonite is kept in the specified salt solutions for 12-24 hour. Repeated washing of bentonite with deionized water is carried out for removal of chlorine anions and sodium salts.

Obtained biocides are applied as additives for the manufacture of building dry mixes; in medicine and veterinary science for antimicrobial treatment of the injured zones of tissues of living organisms; in the preparation of ointments or gels; in preparations for the treatment of surfaces of building products; for the treatment of textile products.

The use of bentonite in Na-form (montmorillonite) for obtaining a biocide is based on the property of this layered clay minerals to be capable of cations exchange.

This property determines an amount of exchange cations (expressed in mg-equivalents) capable to be replaced by cations of other type. The chosen mineral clay (montmorillonite) possesses the highest capacity of cations exchange.

The processes of activation and intercalation substantially depend on the sizes and the specific surface of modular particles of bentonite and their hydrophilic properties.

According to the patent the size, the specific surface of particles of bentonite and their hydrophilic properties, basically depend on the softening and stratification of modular particles of bentonite under action of reacting water solutions that increases consumption of water, reactants and time for obtaining the biocide.

The biocidal properties of the obtained product are also determined by the degree of its cleaning from exchange alkaline metals.

According to the known process the cleaning consists in repeated washing of the product with deionized water and that results in increasing the costs for obtaining the biocide, at the same time decreasing the concentration of metal ions having bactericidal action in the obtained biocide and does not exclude the presence of undesired ions of alkaline metals in the obtained product.

### BRIEF DESCRIPTION OF THE FIGURE

FIG. 1 shows the IR spectra of intercalated bentonite in Ag-form (variation of optical density on wave number) with and without application of Ultrasonic processing (according to examples 1.1 and 1.2 respectively).

### BRIEF DESCRIPTION OF THE INVENTION

Scope of the invention is to make available a process for the preparation of a biocide based on bentonite intercalated by ions of metals with effective bactericidal and fungicidal properties involving less costs in terms of reactants and process time.

The result of the new process is an increased efficiency of action of the obtained biocide when applied m preparations and compositions intended for bactericidal and fungicidal use.

The present process comprises the following steps:
first, bentonite in Na-form is activated by ions of sodium by treating it with chloride sodium in water solution followed by removal of chlorine anions by washing and filtering;
in the second step the above obtained intermediate product is intercalated with ions of metals having bactericidal action by treatment with water solutions of inorganic salts of these metals, followed by removal of sodium salt by washing of the product with deionized water.

Then the obtained product is filtered, dried and ground up to particles dimensions of 20-150 nanometers.

According to the invention the steps of activation and intercalation of bentonite are carried out with application of ultrasound with frequency 20-50 kHz and intensity 10-100 Wt/cm².

The cleaning of the intercalated product from sodium salts is preferably carried out in two stages:
in the first stage the product is decanted and
in the second stage it is washed out in deionized water containing 30 ppm-100 ppm of a complexing agent for ions of alkaline metals, chosen among crown ethers having molecular weight not higher than 264.

According to a particular embodiment of the invention the stage of activation of bentonite in Na-form with ions of sodium is carried out using a 3-7% water solution of chloride sodium and the stage of intercalation is carried out using 8-15% water solutions of inorganic salts of metals having bactericidal action.

According to the invention 3% water solution of chloride sodium is preferably used in the step of activation of bentonite in Na-form by ions of sodium; the reaction is carried out at a ratio bentonite:water solution 1:(10-40) parts by weight.

According to the invention 9% water solution of inorganic salts of metals of bactericidal action is preferably used in the intercalation step; the reaction is carried out at a ratio: bentonite:water solution, as 1:(10-40), weight parts.

According to the invention silver nitrate, copper sulfate, zinc sulfate or nitrate as inorganic salts of metals of bactericidal action are preferably used.

According to the invention crown-ether 18-crown-6 is preferably used as complexing agent of ions of alkaline metals.

The process according to the invention is less expensive in terms of used reactants and process time; biocides based on nanoparticles of bentonite intercalated by ions of metals having bactericidal action are obtained. These biocides provide effective bactericidal and fungicidal action on microorganisms and colonies of fungus by treating the surfaces of various fabrics, polymers, building (including medical) products, at external processing of integuments of warm-blooded beings.

The technical features of the process can be summarized as follows:
Use of natural mineral bentonite in Na-form: level-by-level arrangement of “packages” of negatively charged aluminum-oxygen and silica-oxygen compounds which have high sorption activity is characteristic for the structure of a crystal lattice of bentonite;
Use of ultrasounds: ultrasounds have an influence on water systems of bentonite, with specified frequency and intensity that forms a specific surface of the particles directly participating in activation and intercalation. Particles of montmorillonite are divided and laminated, i.e. their active surface increases at dispersion of sodium bentonites in water with application of ultrasonic energy;
Performing of two stages process for cleaning the intercalated product from sodium salts, i.e. decantation and washing of the product with deionized water containing a crown ether as a complexing agent of ions of alkaline metals. This leads to extraction of alkaline metal-sodium out of the solution. Due to keeping of ions of sodium in an intramolecular cavity of crown ethers during the washing, the probability of reverse intercalation exchange of silver ions on sodium ions is drastically decreased; therefore the qualitative characteristics of biocide result improved.

From the state of the art a process with features corresponding to the ones of present invention and allowing the above described results is not known.

Analysis of the known techniques testifies the conformity of the present application to the criteria of “novelty” and “degree of inventiveness”.

The present process can be industrially realized for manufacturing preparations intended for antimicrobic treatment of wounds, burns, ulcer zones of teguments, for preventive antimicrobic and fungicidal processing of surfaces of fabric, polymeric and building (including medical) products.

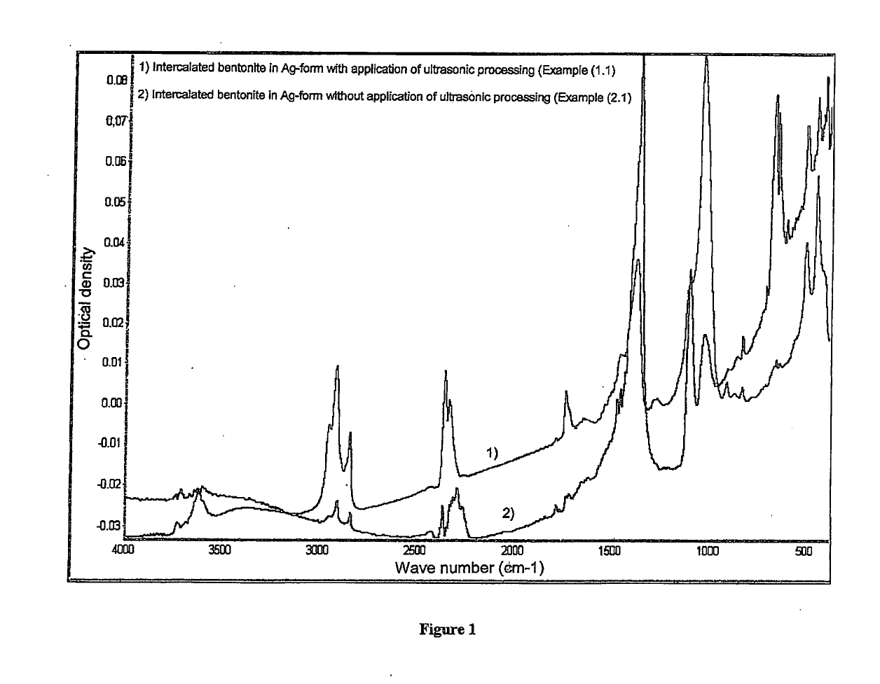

The essence of the invention is explained through indications concerning the choice of raw components for obtaining the biocide, examples of its obtainment and by the results of tests as reported in FIG. 1 that illustrates biocidal activity of biocides according to the invention and according to the known patents.

Ready available medical and labware commodity products and also known technological processes are applied for preparing the biocide according to the process of the invention:
bentonite (montmorillonite) in Na-form; it is the most preferable for the process according to the invention;
silver nitrate (AgNO₃); copper sulfate (CuSO₄); zinc chloride (ZnCl₂) or zinc sulfate, sodium chloride (NaCl);
a complexing agent of ions of alkaline metals: crown-ether 18-crown-6 with molecular weight 264 and belonging to macrocyclic polyethers. Crown-ether is a white crystal powder with fusion temperature 38.6-39.4° C.
deionized water;
ultrasonic equipment Bandelin Sonopuls HD2070.

Performing of the invention by changing the structure of the used components, their ratios, and modifying the technical modalities of operation, will lead to worsening of properties of the produced biocides or to increase in costs of the process for their obtaining.

Performing the invention without respecting the established parameters of ultrasonic influence (frequency 20-50 kHz, intensity 10-100 Wt/cm²) during activation and intercalation of bentonite, will lead to decreased properties of the biocide or to increase in technical-operational expenses.

The activation and intercalation become worse at decrease in frequency and intensity of ultrasound while an increase of frequency and intensity of ultrasound leads to increase in temperature of the used medium, to negative cavitational effects and also to increase operational and power expenses.

Realization of the invention is explained by the following stages and concrete examples.

### EXAMPLES

Stage 1—manufacturing of semifinished products of bentonite.

Intermediate products of bentonite are obtained in this step, according to examples 1 and 2.

### Example 1

Bentonite (montmorillonite) in Na-form in the amount of 10 g is saturated with 3% water solution of NaCl at a ratio bentonite : solution 1:40, weight parts. Ultrasonic processing of the system <<bentonite—reaction solution>> is carried out under application of ultrasounds with frequency 20 kHz and intensity of 15 Wt/cm² during 15 minutes.

Dispersion of the system with simultaneous activation of bentonite particles in a solution by ions of sodium occurs in result. During ultrasonic processing the temperature of the reaction system increases of 5° C. Then washing of the intermediate product by deionized water is carried out not less than two times for removal of anions of chlorine. After it a filtration through the filter <<a white tape>> and drying is carried out.

### Example 2

Bentonite (montmorillonite) in Na-form at amount of 10 gr. is saturated with 5% water solution of NaCl at a ratio: bentonite : solution 1:40, weight parts. Then it is kept in the given solution during 12 hours for activation of modular particles of bentonite by sodium ions.

Repeated (not less than two times) washing of the intermediate product with deionized water for removal of chlorine anions and a filtration through the filter <<a white tape>> and the subsequent drying is carried out.

### Stage 2—Obtaining of the Biocides

Biocide on the basis of nanostructured bentonite intercalated by ions of metals having bactericidal action are obtained from the intermediates of the previous step according to the following examples:

### Example 1.1

The intermediate obtained in Example 1 is saturated with 9% water solution of silver nitrate (at red illumination). Ultrasonic processing of the system <<bentonite—reaction solution>> is carried out for 20 minutes with frequency of ultrasound 30 kHz and intensity of 15 Wt/cm².

Dispersion of the system <<bentonite—reaction solution>> occurs and reactions of ionic replacement of sodium cations (Na⁺) by silver cations (Ag⁺) occurs. The process is carried out at a temperature of no more than 35° C. and the suspension obtained after ultrasonic treatment is decanted giving a moist residuum that is washed in deionized water with addition of crown-ether 18-crown-6. Concentration of crown-ether 18-crown-6 in deionized water was 40 ppm (40 mg) per one liter of water. Filtration and drying preferably at temperature of no more than 80° C. is carried out. The obtained product is ground after drying.

Bentonite powder intercalated by ions of silver Ag⁺ is obtained, 9.8 g of product are collected.

### Example 1.2

The same process of Example 1.1 is performed but 9% water solution of copper sulfate (CuSO₄) is used. There is a replacement of sodium cations (Na⁺) by copper cations (Cu²⁺), during reactions of ionic exchange 9.8 g of product are collected.

### Example 1.3

The same process of Example 1.1 is performed but 9% water solution of zinc chloride (ZnCl₂) is used. There is a replacement of sodium cations (Na⁺) by zinc cations (Zn2⁺) during reactions of an ionic exchange, 9.8 g of product are collected.

### Example 2.1

The intermediate product obtained in Example 2 is saturated with 10% water solution of silver nitrate (at red illumination). Then it is kept for 20 hours and in result there is a softening and stratification of modular particles of bentonite with synchronous reactions of ionic replacement of sodium cations (Na⁺) by silver cations (Ag⁺). The process is carried out at a temperature of no more than 30° C. The obtained suspension is decanted giving a moist residuum of bentonite which is washed in deionized water. The washing is carried out repeatedly not less than five times. Filtration and drying preferably at a temperature of no more than 80° C. is carried out. The obtained product is ground after drying; 9.7 g of product are collected.

The preparation of a biocide by Example 2.1 is carried out according to the known patent RU 2330673.

The content of silver and copper was determined in biocides obtained by Examples 1.1-1.2 and 2.1. The method of the quantitative analysis based on measurement of volume or weight of a reagent required for reaction with researched substance—the titrimetric analysis—was used.

The titrimetric analysis for determination of the amount of silver and copper in the given examples was carried out using the indicators fixing a point of equivalence of titration.

For example, a mix of sulfuric and nitric acids was used as reagent of decomposition in the titrimetric analysis for determination of weight % content of silver in the analyzed samples. A solution of ammonium thiocyanate (or potassium) was used as a titrant and a solution of ferric alum was used as the indicator.

As a result of the carried out analysis it has been established that the tested sample of (Example 1.1) contains 2.95% b.w. of silver;

the tested sample (Example 2.1) contains 2.35% b.w. of silver;

the content of copper and zinc in the samples of Examples 1.2 and 1.3 is 2.49% b.w.

The results testify the efficiency of the process according to the invention.

Biocides obtained by Examples 1.1 and 2.1 were tested by IR-spectroscopy (infra-red spectroscopy) for confirmation of efficiency of the process. The condition and the degree of efficiency of intercalation of nanodispersed particles of bentonite (montmorillonite) in the Ag-form were tested.

Water solutions of biocides in the Ag-form by Example 1.1 and Example 2.1 have been used in the comparative test.

As a result it is ascertained that IR-spectrum of tested biocides in the Ag-form essentially differ for the content of ions of silver (Ag⁺) in interlayer space of intercalated bentonite (FIG. 1).

Tests of biocides by Examples 1.1-1.3 and 2.1 have been carried out for confirmation of efficiency of bactericidal and fungicidal properties of biocide obtained according to the invention.

Appropriate tests were carried out with use of the Standard for <<Control of sterility of dressings>> RD64-051-87. It corresponds to standard ways of determination of microorganisms on work surfaces of gauze, fabric bandage, napkins and so forth, on metal and silicon surfaces of the medical equipment, etc.

Tests were carried out in sterile conditions using sterilized equipment and materials. The following materials have been used in the tests:
Petri's cups treated with a sterilized beef-extract broth (BEB), with pH 7.2-7.4. The thickness of cooled layer BEB is 2-3 mm;
the sterilized gauze-cotton wool tampons (samples). The quantity of tested samples prepared in Examples 1.1-1.3, 2.1 corresponds to the quantity of tests performed for determination of microorganisms Staphylococcus aureus, barmy cells Candida utilis, on the processed materials.

Tests were carried out for 4, 8, 10, 14 days at retention of the gauze-cotton wool samples in usual conditions. The samples were placed in Petri's cups processed by BEB. Before retention the tested samples have been processed by the obtained preparations in the amount of 3 g of a preparation per 1 cm².

As a result of the tests on the products of Examples 1.1-1.3, 2.1 it is ascertained:
absence of colonies of microorganisms Staphylococcus aureus and Candida utilis on the surface of the tested samples processed by the products according to Examples 1.1 and 1.2-1.3, respectively for 14 and 10 days;
absence of colonies of microorganisms Staphylococcus aureus on the surface of the tested samples processed by the preparation according to example 2.1 for 8 days.

Thus, the carried out researches confirm as a whole high efficiency of bactericidal and fungicidal properties of biocide under the present invention, in relation to various colonies of microorganisms what testifies to expediency of application of the invention:
for antimicrobic processing of wounded, burn, ulcer zones of integuments;
for processing of surfaces of building products.

Obtained biocide has no contra-indications and possesses high absorption, ion-exchanging and anti-inflammatory properties.

1. Process for obtaining a biocide comprising the following steps:
bentonite in Na-form is activated with sodium ions by reaction with a water solution of sodium chloride followed by the removal of chloride anions by washing and filtration;
the obtained intermediate product is intercalated by ions of metals of bactericidal action by its processing in water solutions of inorganic salts of the mentioned metals with the subsequent removal of sodium salts by washing the product with deionized water, filtration, drying and grinding up to particles dimensions 20-150 nm
characterized in that ultrasounds with the frequency 20-50 kHz and intensity 10-100 Wt/cm² are applied in the steps of activation and intercalation of bentonite.

2. The process according to claim 1 wherein the cleaning of the intercalated product from sodium salts is carried out in two stages: at the first stage the product is decanted and at the second stage it is washed with deionized water containing 30-100 ppm of a complexing agent for the ions of alkaline metals, chosen among crown ethers with molecular weight not more than 264.

3. The process according to claims 1 wherein a 3-7% water solution of chloride sodium is used at the stage of activation of bentonite in Na-form by sodium ions and a 8-15% water solutions of inorganic salts of metals having bactericidal action is used at the stage of intercalation.

4. The process according to claim 3 wherein 3% water solution of chloride sodium for activation of bentonite in Na-form by sodium ions is used and processing of the mentioned mineral clay is carried out at a ratio bentonite:water solution 1:(10-40), weight parts.

5. The process according to claim 1 wherein 9% water solution of inorganic salts of metals of bactericidal action for intercalation of intermediate product of bentonite by ions of metals is used, and processing of the mentioned mineral clay is carried out at a ratio bentonite: water solution 1:(10-40), weight parts.

6. The process according to claim 1 wherein silver nitrate, copper sulfate, zinc sulfate or nitrate as inorganic salts of metals having bactericidal action are used.

7. The process according to claim 2 wherein crown-ether 18-crown-6 as a complexing agent of ions of alkaline metals is used.

8. Biocides possessing fungicidal and bactericidal properties obtained by the process according to claims 1.

9. (canceled)
